(19) United States
(12) Patent Application Publication
(10) Pub. No.: US 2016/0272341 A1
(43) Pub. Date: Sep. 22, 2016

(54) AIRCRAFT ENVIRONMENTAL MONITORING AND ALERTING DEVICE

(71) Applicant: AIRBLY INC., Argyle Shore (CA)

(72) Inventors: Christopher Van Horn, Argyle Shore (CA); Steve Bornstein, Fairfax, VA (US)

(21) Appl. No.: 15/070,528

(22) Filed: Mar. 15, 2016

Related U.S. Application Data
(60) Provisional application No. 62/134,192, filed on Mar. 17, 2015.

(51) Int. Cl. B64D 45/00; G08G 5/00; G07C 5/08; G07C 5/00

(52) U.S. Cl. CPC B64D 45/00; G07C 5/008; G08G 5/0013; G07C 5/0841

(57) ABSTRACT

A device, system and method improve operational safety and aid in the ongoing maintenance and management of an aircraft. The device continuously monitors several sensors to perceive the environment inside and/or outside of the aircraft cabin. Readings are sent periodically or in real-time or instantaneously to a ground station. The ground station logs the readings and creates a detailed aircraft log to aid in the maintenance and management of the aircraft. If the device detects an unsafe value or change from one of the sensors, it will trigger an alarm to alert the pilot. The alert will also be transmitted to the ground station. The unsafe value or change that automatically triggers the alarm is indicated on the device and aids the pilot in taking corrective action. The pilot or passenger may also manually trigger the alarm and notify the ground station that there is an immediate need for help.

### CROSS-REFERENCE TO RELATED APPLICATIONS

The present application claims the benefit of the filing date of U.S. Provisional Application No. 62/134,192 filed Mar. 17, 2015, the disclosure of which is hereby incorporated by reference.

### BACKGROUND

Aviation has long been a field of growing innovation. For small aircraft owners, aircraft technology has progressed over the years and has increased flight safety. Yet, still there remains a large need to further safety and address concerns for aviators of both large and small aircrafts.

For small aircraft, for example, typically the heat derived from the engine of a single engine aircraft is utilized to heat the inside of the cockpit cabin for its occupants. The safety concern for such small engine aircrafts include addressing the situation when the engine manifold rusts or leaks due to wear or environmental conditions such as long term exposure to rain, ice, and snow. The engine manifold may leak carbon monoxide (CO) into the cabin causing hypoxia or asphyxiation of the pilot.

Multiple attempts to assist the pilot in such situations have several drawbacks. For example, an aviation hypoxia monitor as disclosed in U.S. Pat. No. 5,372,124A discloses a hypoxia monitor incorporated into the headphones worn by a pilot. A pulse oximeter probe is mounted on the ear seal of the headphone so that it contacts the skin beneath the ear of the pilot. The monitor provides a visual and audio signal to the pilot if the blood oxygen level of the pilot decreases significantly. The drawback of this device is that it is only directed at use for the pilot and not everyone in the cabin. Furthermore, when carbon monoxide poisoning takes place, it is a gradual process. However, the onset of drowsiness can be very swift, and unless action is taken immediately to decrease exposure and reverse the concentration of CO in the blood, unconsciousness will be inevitable. If the pilot is unable to respond, others in the cabin may not be aware of the safety risk. Further, no one on the ground is aware of the safety concern.

Another attempt to solve this safety concern is shown in U.S. Pat. No. 6,452,510. It discloses a cabin pressure altitude monitor and warning system. When a detected cabin pressure altitude has reached a predetermined level, a visual, audible and tactile warning signal is given. The system is also designed to detect gas concentrations and other ambient conditions. This device however fails to provide an early warning detection. The alarm is activated only when the altitude or CO has reached a predetermined level, which in many cases is too late for the pilot to act upon because the pilot is either unconscious or unresponsive at that point. There is no constant monitoring as to whether cabin altitude or CO level is changing rapidly within above the predetermined level. A pilot would not be able to take precautions or measures before the plane cabin pressure falls below the predetermined level or reaches a pre-set CO level.

In U.S. Pat. No. 7,246,620 disclosed is a noninvasive system for monitoring the oxygen saturation level of a pilot. The system is part of the multifunctional instrument panel in an aircraft and monitors a person's oxygen saturation level, comparing the saturation level to a predetermined level. When the measured saturation level is less than the predetermined level, the person is then supplied with an oxygen mixture for increasing the subject's oxygen saturation level to a safe level. The person's exposed reduced atmospheric pressure is also compared with a predetermined range of pressure levels. If this predetermined range of pressure levels is exceeded or maintained for a pre-determined time duration, the person is then supplied with an oxygen mixture. Further emergency procedures include transmitting an automatic emergency message to a pre-programmed airport tower. The drawbacks with this device are that it is not portable for small aircraft pilots that may switch aircrafts from time to time. Further drawbacks include having a set predetermined level or time frame. As other devices of this type, the pilot may be unresponsive such that even increases in oxygen levels in the cabin may be too late to avoid an emergency situation. Further the emergency signal sent to a ground tower is a single signal only after disaster has occurred. There is no precautionary communication between the aircraft and the ground tower.

Thus there still remains a need in the art to provide a device that continuously monitors several sensors in the aircraft to perceive the environment inside and/or outside of the aircraft cabin. There is also a need to utilize continuous readings and send the readings periodically to aground station to avert an emergency situation before it happens in the aircraft.

### BRIEF SUMMARY

The device, system, and method of the present invention solves the problems created by present aircraft monitoring systems and also provides solutions that allow continuous monitor of conditions inside and/or outside the aircraft to avert emergency conditions before they happen as well as provide vital information for maintenance of the aircraft.

The advantages of the present invention include continuous monitoring using several different types of sensors, such as but not limited to, CO sensors, temperature, altitude sensors, position sensors, cabin pressure sensors, humidity sensors, acceleration sensors, and the like, to perceive the environment inside and/or outside of the aircraft cabin. Those readings are sent periodically or in real-time or both, depending on the implementation, to a ground station to continuously monitor the environment both inside and/or outside the aircraft so that the pilot may be alerted of a potential detrimental condition before it happens and while the pilot is still cognizant to react appropriately to the situation. The ground station logs the readings and creates a detailed aircraft log to aid in the maintenance and management of the aircraft.

The device does not connect or interface directly with any part of the aircraft and is completely portable which assists aircraft pilots if they are required to change aircrafts and if such aircraft is not equipped with the device. It instead passively infers the status of the aircraft environment by using values read from the sensors as described in the sensor section herein.

The monitoring occurs on a regular basis, which is programmatically defined and may change during execution of the device firmware and/or software. The device monitors one or more of the parameters listed below: Latitude, Longitude, Heading, Ground speed, Altitude, Barometric pressure, Temperature, Humidity, Acceleration (G-forces) in all three axes, CO (carbon monoxide) gas concentration, Internal battery level, Battery charging status, User accessible buttons and Micro-USB port.

Based on the values of monitored parameters, the device will place itself in the appropriate state described herein.

The device can detect and log when the aircraft engine is started and stopped. This feature is important because general aviation aircraft have strict maintenance guidelines, which are generally dictated by the number of hours the engine is in operation.

The foregoing objects are achieved and other features and advantages of the present invention will become more apparent in light of the following detailed description of exemplary embodiments thereof, as illustrated in the accompanying drawings.

### BRIEF DESCRIPTION OF THE DRAWINGS

FIG. 1A is a right perspective view of a device made in accordance to the present invention;

FIG. 1B is a left perspective view of the device in FIG. 1A

FIG. 1C is a front view of the device in FIG. 1A;

FIG. 1D is a side view of the device in FIG. 1A;

FIG. 2 is a flow chart illustrating one embodiment of the device's states for the device in FIG. 1A;

FIG. 3 is a flow chart illustrating one embodiment of the devices states for the device in FIG. 1A;

FIG. 4 is a flow chart illustrating one embodiment of the devices states for the device in FIG. 1A;

FIG. 5 is a graphical depiction of one example of a communications system for the device in FIG. 1A;

FIG. 6 is a front view of another implementation of the device in FIG. 1A;

FIG. 7 is a side view of the device in FIG. 6;

FIG. 8 is a rear view of the device in FIG. 6;

FIG. 9 is a perspective view of the device in FIG. 6; and

FIG. 10 is an unassembled view of the device in FIG. 9 with a holder.

### DETAILED DESCRIPTION

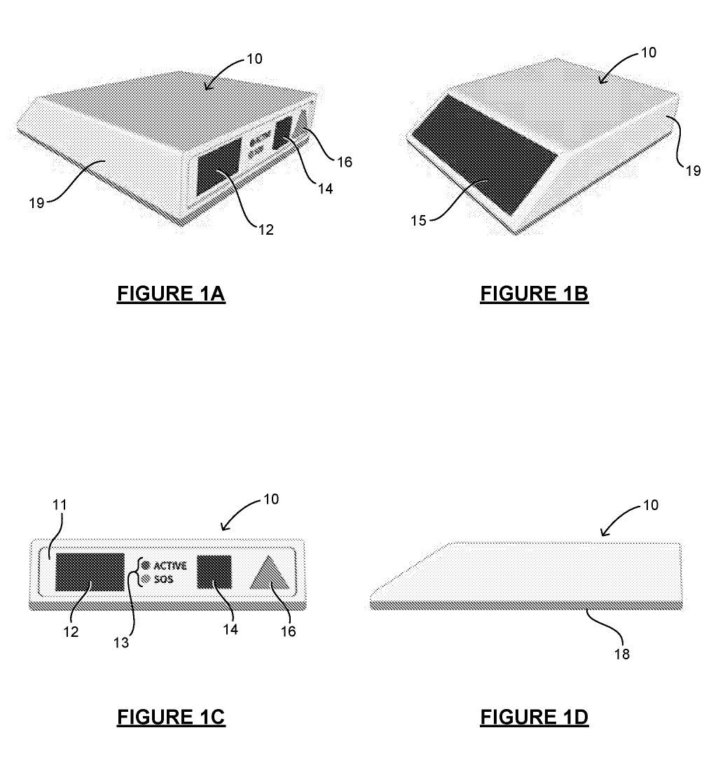

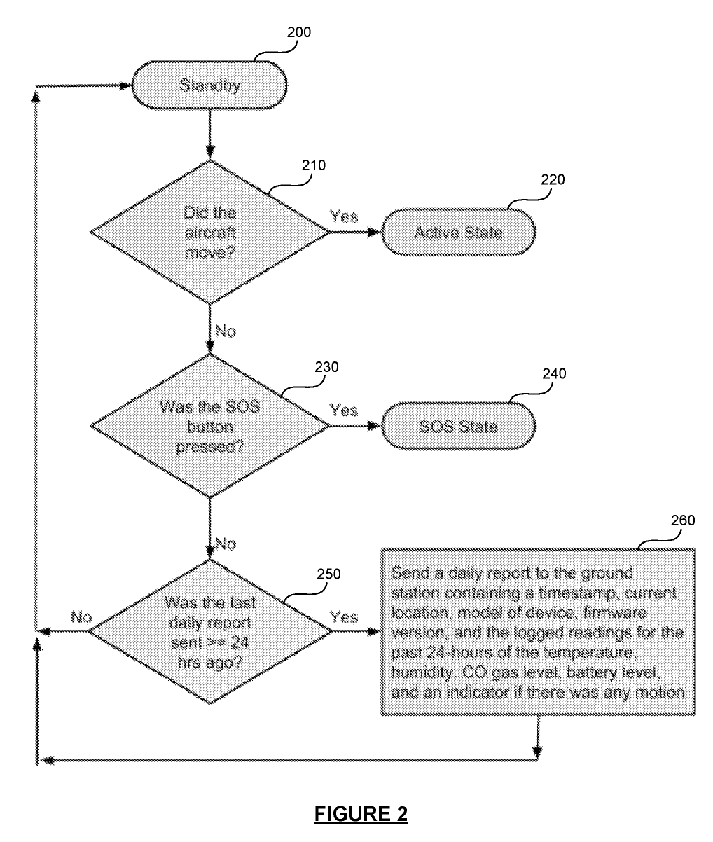

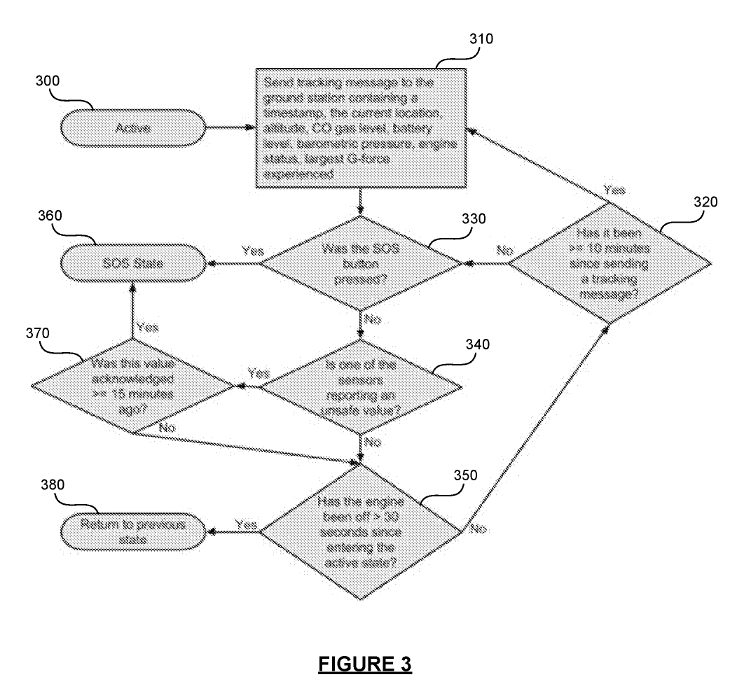

The invention will now be described in detail with reference to the accompanying drawings. The present invention relates to a device, system, and method to improve upon the operational safety and aid in the ongoing maintenance and management of an aircraft. Depending on the embodiment the device may be a small, for example 88 mm×88 mm×32 mm in size or 100 mm wide, 120 mm deep and 25 mm tall, battery-powered portable and can be installed without any technical skills. Shown in FIGS. 1A, 1B, 1C and 1D are exemplary depictions of the device. FIG. 1A shows a perspective view of the Canairy™ assembly device 10. A front panel 11 has a display 12 that gives the user a visual representation of the sensors being monitored inside and/or outside the aircraft. The device 10 is completely portable and may be utilized inside and/or outside the cabin of any aircraft. Signal light 13 gives the user visual information regarding the status of the device 10 in active or SOS mode. The device also has an audible alarm system for the user so that both visual and audible detection of a potential emergency situation for the user is continuously provided. Button 14 is a user interface or control button for the device.

As shown on FIG. 1B solar panel 15 is provided on the device. The device 10 is typically mounted in the cockpit of an aircraft with the solar panel 15 facing toward the window so that solar rays may charge the device. The device also has a base 18, that may or may not have a fixing means such as but not limited to, Velcro® striping or mechanical hooks, adhesive striping, suction cup, magnetic holder or the like to removably a fix the device 10 on top of the instrument panel of the aircraft. The housing 19 of the device 10 may be made of lightweight plastic or metal depending on the embodiment.

The device 10 continuously monitors several sensors described further herein to perceive the environment inside and/or outside of the aircraft cabin. Those readings are sent periodically or in real-time or in both depending on the implementation to a ground station. The ground station logs the readings and creates a detailed aircraft log to aid in the maintenance and management of the aircraft. If the device 10 detects an unsafe value from one of the sensors, it will trigger a visual and audio alarm to alert the pilot. The alert will also be transmitted to the ground station. The unsafe value that triggered the alarm is indicated on the display, which aids the pilot in taking corrective action. Additionally, the pilot can manually trigger an alarm and notify the ground station that he/she is in need of immediate help.

The device 10 provides more features than currently available. Most design alarm systems are specifically for commercial aviation purposes, and in most cases can only accomplish one or two tasks. The device of the present invention increases the safety of flying general aviation aircraft at a cost that is within reach of most general aviation pilots. Monitoring is done continuously to sound an alarm if unusual patterns of change are detected by one or more sensors, unlike other monitoring systems that only give an alarm when a pre-determined threshold is reached.

The device 10, depending on the embodiment contains a processor configured to set off a visual alarm or an audio alarm or both the visual alarm and the audio alarm for unacceptable changes in carbon monoxide readings, acceleration readings and cabin pressure readings inside and/or outside the aircraft. Further depending on the embodiment any of the above alarms may be triggered if one or more of the above monitored aircraft parameters or other monitored parameters reach unacceptable changes and/or exceed predetermined levels.

The device 10 is extremely energy efficient. It can operate on an internal battery (not shown) for 4 months in a standby mode, 4 days in an active mode and 2 days in a SOS mode without recharging. The device can be removed from the aircraft and taken with the pilot in the event the pilot has to leave the aircraft in an emergency. The built-in solar panel 15 which can charge and maintain the battery can charge a depleted battery to a full charge in approximately 12 to 14 hours. The solar panel 15 can maintain that full charge with about 10 minutes of sunlight exposure per day. There is not a need to interact with the device unless the pilot wanted to manually activate a warning system, however, such manual activation by button 16 is not necessary as any unusual conditions or changes even if within predetermined unacceptable levels are automatically relayed to the pilot and the ground tower or designated receiver. The ability to monitor in real-time even the slightest fluctuations in conditions inside and/or outside the aircraft allow the pilot additional time to react to potentially unsafe flying conditions.

Audio and visual alarms are supplied for high carbon monoxide readings and low cabin pressure readings. These are the two most common invisible environmental issues that occur in the cabin of general aviation aircraft. And in many cases, they result in fatal accidents. Humidity inside of the aircraft can lead to structural concerns that cannot be seen through the pre-flight inspection. The device 10 monitors the humidity in the aircraft and sends daily reports to the owner.

The device 10 is quite small. Typical measurements, are for example, but not limited to, measurements of about 88 mm×88 mm×32 mm in size. The small size allows device 10 to be placed on top of the instrument panel without obstructing the pilot's vision.

Depending on the embodiment, the device 10 may or may not be not only equipped with lights and audio alerts, but also a display 12. Depending on the embodiment, detailed information may be provided by the device 10 to the pilot, such as level of CO concentration, the altitude the cabin is pressurized to, and the trend of those readings. This feature of alerting the pilot as to the trend in changes, whether done by light alerts, audio alerts, or a display can aid the pilot in making a more informed decision to correct the problem.

The device 10 consists of a case 19 containing a microcontroller, firmware, battery, sensors, lights 13, display screen 12, buttons 14 and 16, audible device, micro-USB port, and solar panel 15. These components are described in more detail below. Device 10 is designed to sit on top of the instrument panel of the aircraft and in view of the pilot, however not blocking the view of the pilot. The device 10 does not connect or interface directly with any part of the aircraft. Instead, it passively infers the status of the aircraft environment by using values read from the sensors as described herein.

The device 10 monitoring occurs on a regular basis, which is programmatically defined and may change during execution of the device firmware. The device 10 continuously monitors the parameters inside and/or outside the aircraft, such as but not limited to: Latitude, Longitude, Heading, Ground speed, Altitude, Barometric pressure, Temperature, Humidity, Acceleration (G-forces) in all three axes, CO (carbon monoxide) gas concentration, Internal battery level, Battery charging status, User accessible buttons, Micro-USB port, and any combination thereof.

Based on the values of monitored parameters, the device 10 places itself in the appropriate state. These states are described below.

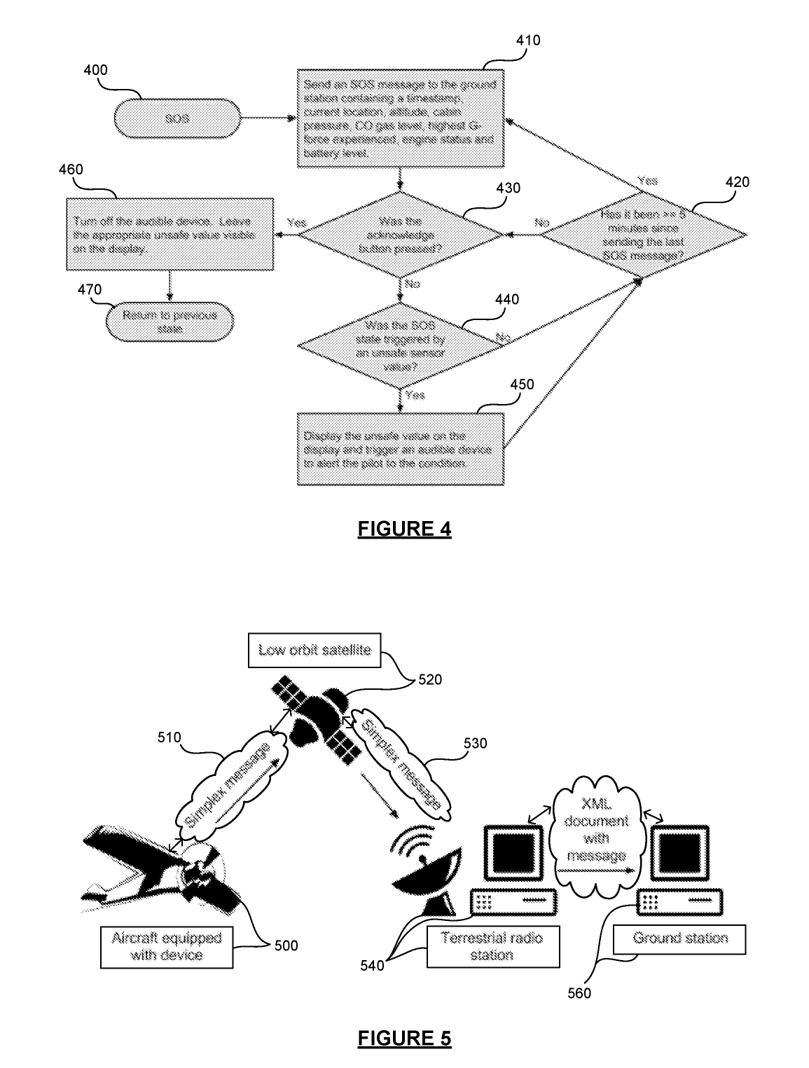

As shown in FIG. 2, a standby mode 200 is available for device 10. The device 10 will spend most of its time in the standby state. This state consumes the least amount of energy in order to prolong battery life. In this state, the device periodically checks for an event as shown in query block 210 that will cause it to leave standby mode. Typically, the device will remain in this mode while the aircraft is parked and motionless. On a daily basis, the device will report the environmental readings collected throughout the day to the ground station.

When the aircraft is in use, the device will be in active state 220. The device will spend most of its time in this active state when the aircraft is in use. The device 10 will enter this active state whenever any motion above a defined threshold is sensed. The device 10 actively collects environmental information and regularly relays it to the ground station. This mode consumes a medium amount of energy. There is an indicator light on the device that blinks to inform the pilot that the device is active.

FIG. 2 also shows as shown in query block 230 when the SOS button is pressed (14 or 16) then the device goes into an SOS state or mode 240. In this SOS mode 240, the device 10 is indicating that the aircraft is in distress. This SOS mode 240 can be triggered passively or actively. A passive trigger occurs when the device 10 itself detects an unsafe sensor value and enters SOS mode automatically. The conditions that may cause the device to enter SOS mode 240 are described in the Safe Operating Values section below. When the device enters SOS mode 240 passively, it will also alert the pilot with flashing lights and an audio alert. SOS mode 240 can also be entered actively if the pilot presses and holds down the SOS button for a distinct period of time. The only way to exit SOS mode 240 is if the pilot presses and holds the acknowledge button for distinct a period of time. Pressing the acknowledge button to clear a passive alarm will only snooze that alarm for a distinct period of time. After that duration has expired, the device will re-enter SOS mode 240 if the conditions that caused the alarm are still present.

The device 10 also queries whether a daily report was sent to the ground tower or other computer system as seen in query 250. The other computer system may include for example, but is not limited to an outside service, private ground crew, tower control, FAA, personal computer, aircraft manufacturer, aircraft hangar maintenance crew, or any combination thereof. If the report was not sent the device loops to standby and continues the process as shown in FIG. 2. If the daily report was sent then it may contain a time and date stamp and give a 24 hour temperature, humidity, CO gas level, battery level and indicator of motion printout or indication of those and other readings for inside and/or outside the aircraft.

As shown in FIG. 3, a typical Active mode 300 is shown. When Active mode 300 is activated the device 10 sends tracking messages as shown in block 310. Query 330 asks was the SOS button activated, if yes then SOS state 360 is instituted. If no, then is one of the sensors reporting a safe value as shown in query 340. If yes, then query 370 asks was the value acknowledged greater than or equal to 15 minutes ago. If no, query 350 is asked has the engine been off for a duration of time. If 370 query is yes, then SOS state 360 is activated. Query 350 asking if the engine has been off for a duration of time, if answered yes, then the device 10 returns to its previous state as shown in block 380. If no, to query 350, then Query 320 is asked. Query 320 asks if there has been greater than or equal to 10 minutes or some other time frame since sending a tracking message. If yes to 320, then a tracking message is sent to a ground station. If no to query 320, then query 330 is asked as described above.

FIG. 4 shows a typical SOS routine. When SOS mode 400 is activated either passively or actively, an SOS message is sent to the ground control as shown in block 410. Query 430 asks was the acknowledge button pressed on device 10. If yes, then the audible device is turned off as shown in block 460 and the device is returned to its previous state as shown in 470. If no then query 440 asks was the SOS triggered by an unsafe sensor value. If yes, then block 450 indicates the display of the unsafe value is shown and an audible alarm is activated to alert the pilot. As shown in query 420, if it has been greater than or equal to certain duration of time, for example, 5 minutes, then the SOS message is sent to the ground station as shown in block 410. If no, then query 430 is asked as previously described.

Depending on the implementation, if the device 10 detects that it is connected to a computer via the USB connector, it will enter a bootloader mode. Bootloader mode allows the device firmware to be upgraded in the field as well as make changes to the device configuration. Alternatively the Bootloader mode may be activated wirelessly through wireless communication such as, but not limited to a radio frequency signal (RF) such as Bluetooth. Microwave signals or other such signals may also be used so that the operator may utlize devise such as a smartphone, tablet or the like to activate the Bootloader mode and/or in addition to the USB connector. This feature gives the operator the option to upgrade the device firmware and/or software using their electronic devices such as, but not limited to, a smart phone or tablet.

FIG. 5 illustrates communication capabilities of the device 10. The device 10 in aircraft 500 communicates indirectly with a ground station 560 via a radio transmission such as 510 and 530. The radio transmission can either be directed to a terrestrial radio station 540 directly, or relayed by a satellite 520 to the terrestrial radio station 540. The terrestrial radio station 540 will decode the radio transmission and encode it into an XML document 550. The XML document 550 will then be sent to the ground station 560 over a network for processing.

The device 10 monitors the changes in acceleration experienced by the accelerometer to determine if the engine is on or off. This device looks for sustained periods of regular vibration in three directions as detected by the accelerometer. If the rate and direction of vibration falls within a threshold, the device 10 will indicate that the engine is currently running. If the vibration is not regular or does not fall within the acceptable threshold, the engine is considered to be not running. This allows the device to transmit to the ground station the precise amount of time the engine was operational and the aircraft was in use.

In addition the device monitors the changes in acceleration experienced by the accelerometer to determine if the aircraft impacted an object such as the ground. If the rate of acceleration exceeds a safe threshold, the device will indicate this to the pilot and the ground station.

Furthermore, depending on the implementation, the device monitors the changes in latitude, longitude, altitude, ground speed, acceleration and heading, as measured by GPS and acceleration sensors, to determine if the aircraft is on the ground or in the air. If the ground speed of the aircraft exceeds a safe taxi speed and the altitude changes at or above a defined rate, the aircraft is said to be in flight. This allows the device to transmit precise takeoff and landing times to the ground station.

The device monitors the status of the engine and the in-flight status of the aircraft. In the event that the aircraft is in-flight and the engine is considered off, an engine failure may have occurred. This conflicting status will be indicated to the pilot and the ground station.

Additionally, the device monitors the change in an electrochemical carbon monoxide detector to determine the concentration of carbon monoxide in the cabin. This device considers elapsed time and the carbon monoxide concentration levels to determine if the quality of the air in the cabin is safe. If the concentration level of carbon monoxide is not below a safe threshold, the device will indicate this to the pilot and the ground station.

A temperature and humidity sensor in the device is read on a regular basis. The values recorded from this sensor are sent to the ground station on a daily basis.

Depending on the implementation, the device monitors a barometric pressure sensor to determine what the air pressure is within the cabin. The cabin pressure is then compared with changes in the aircraft altitude as read from the GPS sensor to determine if the cabin pressure is safe and if supplemental oxygen is required. If the cabin pressure is not of a safe value, the device will indicate this to the pilot and the ground station.

Depending on the embodiment, the device has several indicator lights and a visual display. Active LED—blinks regularly when the device is in the active state. SOS LED—blinks regularly when the device is in the SOS state. In another implementation the display can indicate detailed sensor and state information with graphics and/or text. Such information will include battery level, CO level, cabin pressure level, SOS status, GPS signal level and engine on/off status. A display may or may not be used with the device.

The device 10 again has an audible alarm, which will sound when the device is in SOS mode as a result of an unsafe sensor value. An alarm will not sound when the SOS is triggered by the pilot. The audible alarm can be silenced by pressing the acknowledge button to reduce the distraction.

The device has an internal power supply and depending on the implementation may also include solar capability. Depending on the implementation, the internal power supply may be a lithium ion battery, which provides power to the device. The battery can be charged either by the built-in solar array 15 or through an external power source attached to the micro-USB port. Depending on the implementation the battery may also be a lithium iron phosphate battery. The device may also be utilized with non-rechargeable and disposable batteries instead of the rechargeable type batteries and may also run off both rechargeable and non-rechargeable batteries depending on the implementation. In a further implementation the device may run off of the electrical power provided by the aircraft.

The device 10 has field upgradable firmware. The firmware can be upgraded by attaching the device to a computer via the micro-USB port and then running a firmware upgrade application on the computer. The device can also be configured through the USB port. Depending on the implementation, the device may be equipped with transmitting a radio frequency (RF) signal such as Bluetooth wireless communication. The Bootloader mode may be triggered over a Bluetooth wireless communication from, for example, a smartphone, tablet or the like in addition to or instead of the USB connector. This feature allows the operator to upgrade the device using a smartphone, tablet or other such wireless communication device.

The ground station is made up of one or several internet connected computers. These computers receive messages transmitted by the device. These messages are decoded, processed and stored in a database at the ground station.

The environmental conditions collected by the device inside the cabin are sent to the ground station daily. These conditions will include for example, but are not limited to: Temperatures, Humidity levels, CO levels, Barometric pressure, Battery level, Battery charge status, Aircraft movements and any combination thereof.

Additionally, the ground station will log the aircraft usage. These conditions will include for example, but are not limited to: Engine start time, Engine shutdown time, Aircraft departure location and time, Aircraft arrival location and time, Periodic locations while enroute, Periodic altitudes while enroute, Periodic G-force values while enroute, Time enroute, SOS alerts, and any combination thereof.

If the pilot operating the aircraft is known, the ground station can link the aircraft log to the pilot, which allows the automatic creation of a pilot's log. The pilot can be known either by scheduling the aircraft for use or by manually linking the pilot to the flight using the available web service or smartphone app.

The ground station can be configured to send automatic alerts to select recipients when particular parameters are met. These alerts can include, for example but are not limited to: Aircraft flown outside a designated geo-fenced area, Aircraft flown inside a designated geo-fenced area, Aircraft environmental value exceeds a set threshold, An SOS alert message is received, Aircraft movement when it is not scheduled, Aircraft departure at any or a particular location, Aircraft arrival at any or a particular location, Aircraft engine is started or shutdown, and any combination thereof.

The ground station can also optionally be configured to interface with social media or other internet-connected systems. For example, it could tweet the arrivals and departures of the aircraft on Twitter or update the pilot's status on Facebook.

The ground station shall have a user accessible web application to allow users to remotely access logs created by the device.

The ground station will make available an Application Program Interface (API) to allow users or 3rd party applications access to the data when permitted to do so.

All communication with the ground station shall be conducted on an encrypted communication channel including, but not limited to, https. All communication with the ground station will require authentication from the user or application attempting to establish a connection.

Safe operating values include for example, but are not limited to the carbon monoxide gas, acceleration and barometric pressure sensor values can indicate that there is an unsafe condition aboard the aircraft. The thresholds of these values are selected using industry suggested thresholds.

As defined in UL2034, carbon monoxide gas is unsafe when either of the following conditions exist:

Concentration of 70 ppm for more than 60 minutes.

Concentration of 150 ppm for more than 10 minutes.

Concentration of 400 ppm for more than 4 minutes.

The 1982 FAA-AM-82-15: Carbon Monoxide In-Flight Incapacitation details that the FAA, when certifying an aircraft, requires a carbon monoxide concentration of less than 50 ppm. As defined in TSO-C91a, an average acceleration equal to or greater than 5.0 g over a period of 11 ms is considered unsafe.

As defined in FAR 91.211 and CFR 91.211, cabin pressure/altitude in which supplemental oxygen masks are required is as follows:
12,500 ft-14,000 ft: after 30 minutes in this altitude range, the aircraft crew must use supplemental oxygen at all times.
Above 14,000 ft: the aircraft crew must use supplemental oxygen at all times.
Above 15,000 ft: the aircraft passengers must use supplemental oxygen at all times.

### SOS Response

In the event of an SOS message that is triggered by an unsafe sensor value, the following shall take place:

The ground station operator shall wait for a second message to determine if the pilot has acknowledged and/or corrected the alarm. If a second all clear message is received within 10 minutes, the alarm will be considered resolved.

If the second message continues to indicate that the SOS was not acknowledged or a second message is not received, the ground station operator shall perform the following:

Attempt to contact any emergency contacts on file. Attempt to communicate with the appropriate emergency services.

In the event an SOS message is triggered by the pilot pressing the SOS button, the ground station operator shall immediately perform the following: Attempt to contact any emergency contacts on file. Attempt to communicate with the appropriate emergency services.

### Safety Expectations

The device and services provided shall be considered supplemental. It may or may not be considered a primary means of alerting the pilot, crew, ground operators, emergency contacts or emergency services to an unsafe situation. The device may or may not be used to meet any requirements set by any governing body.

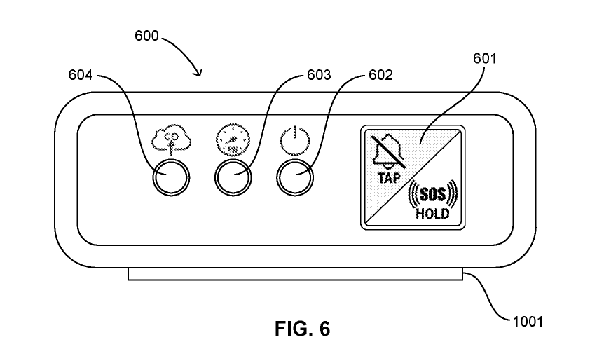

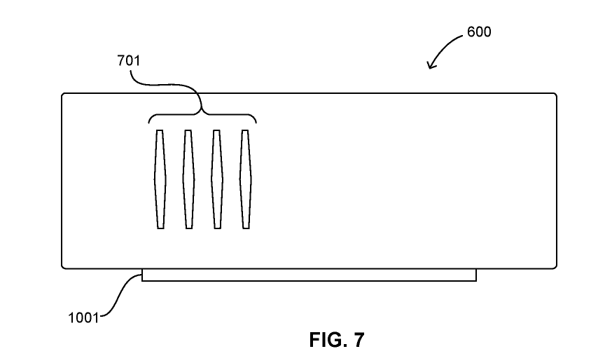

FIG. 6 illustrates device 600. Device 600 may be made from an impact resistance material such as but not limited to nylon, polycarbonate, impact resistant Styrene butadiene and the like. The material may also be water and flame resistant. Indicator light 602 is turned on to indicate that the device is functioning and monitoring as described. Indication lights 603 and 604 are, depending on the implementation for monitoring psi and co gases for the aircraft. Color changes in lights 603 and 604 and/or intermittent flashing may indicate a warning of levels for the parameters measured. Depending on the embodiment the indication lights 602, 603, and 604 may be LCD, LED or the like. Also disposed on a front panel of device 600 is button 601. Button 601 is a single button with dual functions. The button 601 can be tapped once to acknowledge an alarm or held for 3 seconds to trigger a distress signal. The device may or may not be turned on and off by button 601 or by the on/off membrane above indicator light 602. Further including depending on the implementation is a holder 1001. Holder 1001 attaches the device 600 to the aircraft.

As previously described, depending on the implementation, wireless communications may be used with the device. For example, Bluetooth (RF signal) wireless communications, allow a user or operator to configure the device, upgrade the device and/or monitor in real-time conditions. For example, and not limited to, by using another Bluetooth equipped device on the ground other than a Bluetooth equipped device in the aircraft, the ground based Bluetooth device may monitor conditions in real-time in the aircraft.

Further depending on the implementation, the solar panel may be removable or not on the device. In one implementation an internal rechargeable battery that can log 60+ flight hours between charges may be used. Rechargeable batteries, such as but not limited to, lithium iron phosphate may be utilized.

Furthermore, a 3-axis gyroscope may be utilized in the device to supplement the accelerometer and give more information about the aircraft state. A gyroscopic sensor may detect rates of pitch, yaw and roll the aircraft experiences.

Dimensions for the device may vary depending on the implementation. In one implementation the device is 88 mm×88 mm×32 mm in size and thus is very portable and compact.

As previously described, the device may or may not have a display. For example, the single button 601 on the front of the device 600 can be tapped to acknowledge an alarm signal by the device or held down for 5 seconds to trigger an alarm manually. If no display screen is used in the device the battery life is extended as compared to the device with a display screen. In the implementation without a display screen, light emitting diodes (LED) may be utilized to indicate Power/Status, High CO levels and Low Cabin pressure for example. An LED indicator may also be placed on the back or rear of the device to indicate the device is charging.

FIG. 7 illustrates a side view of the device in FIG. 6. Depending on the implementation, vent or vents 701 may be utilized to cool the internal components of the device. Other heat sinks may be utilized inside the device to further the cooling of the electronic components within the device.

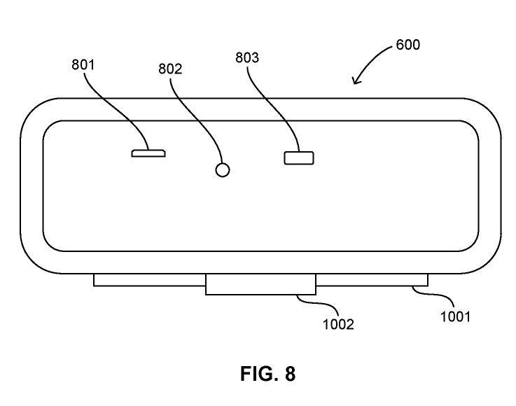

FIG. 8 illustrates a back or rear view of device 600. The device may utilize various inputs ports such as, but not limited to, a HDMI (High Definition Multimedia Interface) port 801, USB (Universal Serial Bus) port 803 and RF (radio frequency) port 802 such as, but not limited to, a F-Type connector or any other input port. The back of the device may also have an indicator light (not shown) to indicate the device is recharging. The holder 1001 may also include a release tab 1002 that is accessed at the back of the device to release the device from the holder. Thus, depending on the implementation, the holder 1001 may be maintained in the aircraft and the device removed.

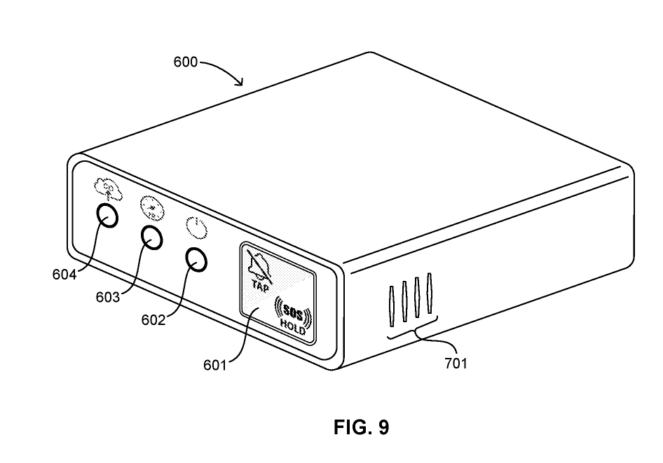

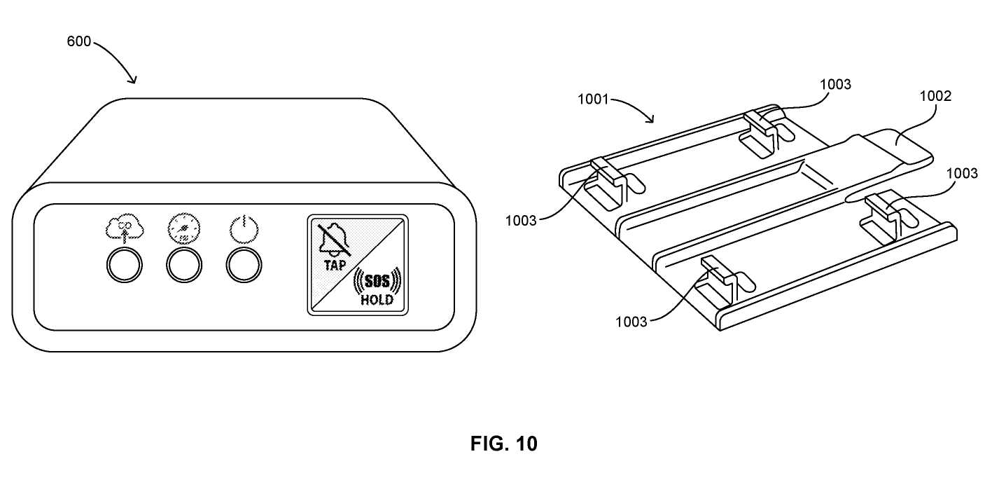

FIG. 9 illustrates a perspective view of the device 600. On the top of the device, depending on the implementation, indicia such as a logo or other identification marks, may be placed on the top of the device 600. FIG. 10 illustrates the device 600 with the holder 1001 detached. Holder 1001 has implements 1003 to clasp onto device 600. Implements 1003 includes, but is not limited to, snap fits, clasps, tabs, and the like. Release tab 1002 may or may not also include implements to attach to the device. The bottom of the holder 1001 has a fixture to adhere to the aircraft. The fixture at the bottom of the holder 1001 may include any known methods of attachment.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A device for improving operational safety and aid in management of an aircraft, comprising:
a memory; and
a processor disposed in communication with the memory device, the processor configured to:
monitor continuously and give at least one reading from at least one sensor to evaluate the environment of an aircraft cabin;
send periodically or in-real time the reading to a ground station;
trigger an alarm if the device detects an unsafe reading from the at least one sensors;
transmit automatically an alert to the ground station when the unsafe reading is detected; and
display the unsafe reading on the device to aid a pilot in taking corrective action.

2. The device as in claim 1 wherein the processor is further configured to manually trigger an alarm and notify the ground station when there is an immediate need for help.

3. The device as in claim 1 further including at least one of a rechargeable battery, a non-rechargeable battery, a solar panel, a power source from the aircraft, or any combination thereof.

4. The device as in claim 1, wherein the processor is further configured to place the device in multiple states or modes based on values of continuously monitored parameters.

5. The device as in claim 4, wherein the parameters are selected from a group consisting of: Latitude, Longitude, Heading, Ground speed, Altitude, Barometric pressure, Temperature, Humidity, Acceleration (G-forces) in all three axes, CO (carbon monoxide) gas concentration, Internal battery level, Battery charging status, User accessible buttons, Micro-USB port, and any combination thereof.

6. The device as in claim 1 wherein the reading to the ground station further includes data on at least one condition for the ground station logging the readings and creating an aircraft log to aid in maintenance and management of the aircraft.

7. The device as in claim 6, wherein at least one condition is selected from a group consisting of: Engine start time, Engine shutdown time, Aircraft departure location and time, Aircraft arrival location and time, Periodic locations while enroute, Periodic altitudes while enroute, Periodic G-force values while enroute, Time enroute, SOS alerts, CO levels, battery level, temperature, humidity level, and any combination thereof.

8. The device as in claim 1, wherein the processor is further configured to monitor changes inside the aircraft, or outside the aircraft, or both inside and outside the aircraft; and the processor does not monitor pre-set values as a basis to trigger the alarm.

9. The device as in claim 8, wherein the changes are selected from a group consisting of: latitude, longitude, altitude, ground speed, acceleration and heading, as measured by GPS and acceleration sensors, and any combination thereof.

10. The device as in claim 1, wherein the alarm is a visual alarm or an audio alarm or both visual and audio alarms and the processor is configured to set off the visual alarm or the audio alarm or both visual and audio alarms for unacceptable changes in carbon monoxide readings, acceleration readings and cabin pressure readings inside the aircraft.

11. A system for improving operational safety and aid in management of an aircraft, comprising:
a device that contains a processor disposed in communication with a memory device, the processor configured to:
monitor continuously and give at least one reading from at least one sensor to evaluate the environment of an aircraft cabin;
send periodically or in real-time the reading to a ground station;
trigger a visual alarm or an audio alarm or both the visual alarm and the audio alarm if the device detects an unsafe reading from the at least one sensor;
transmit automatically an alert to the ground station when the unsafe reading is detected; and
display the unsafe reading on the device to aid a pilot in taking corrective action.

12. The system as in claim 11 further comprising means for monitoring changes, and not pre-set values in conditions of the aircraft.

13. The system as in claim 11 further including a communication system in direct or indirect contact with the ground station.

14. The system in claim 13 wherein the system further includes satellite communication.

15. The system in claim 13 wherein the system further includes XML document messaging or wireless communication to the ground station.

16. A non-transitory computer readable medium used for improving operational safety and aid in management of an aircraft, comprising:
instruction code for monitoring continuously and give at least one reading from at least one sensor to evaluate the environment of an aircraft cabin;
instruction code for sending periodically or instantaneously the reading to a ground station;
instruction code for triggering a visual or an audio alarm or both visual and audio alarms if the device detects an unsafe reading from the at least one sensor;
instruction code for transmitting automatically an alert to the ground station when the unsafe reading is detected; and
instruction code for displaying the unsafe reading on the device to aid a pilot in taking corrective action.

17. The non-transitory computer readable medium as in claim 16 further including instruction code for monitoring changes, and not pre-set values in conditions of the aircraft as a basis to trigger the alert, and alarm or alarms.

18. The non-transitory computer readable medium as in claim 16 further including instruction code for changing the mode of the device from active, SOS, Bootloader, and standby based on parameters.

19. A process of initiating an alarm inside an aircraft, comprising:
monitoring continuously several sensors to evaluate an environment of an aircraft cabin, wherein the monitoring is inside the cabin or outside the cabin or both inside and outside the cabin;
send at specific time intervals a reading of the sensors to a ground station;
create a detailed aircraft log from the reading to aid in maintenance and management of the aircraft;
detect a change in the reading of an unsafe condition from one or more of the sensors;
trigger an alarm to alert the pilot; and
transmit an alert to the ground station.

20. The process of claim 19, further comprising: placing the device in a Bootloader mode to allow the device to be upgraded and make changes to device configurations.
